(19) United States
(12) Patent Application Publication
(10) Pub. No.: US 2016/0174168 A1
(43) Pub. Date: Jun. 16, 2016

(54) AVOIDING TRANSMIT POWER LIMITATIONS DUE TO SPECIFIC ABSORPTION RATE CONSTRAINTS

(71) Applicant: QUALCOMM Incorporated, San Diego, CA (US)

(72) Inventors: Lin Lu, San Diego, CA (US); Jagadish Nadakuduti, La Jolla, CA (US); Paul Guckian, San Diego, CA (US)

(21) Appl. No.: 14/572,266

(22) Filed: Dec. 16, 2014

(51) Int. Cl. H04W 52/26; H04W 24/02

(52) U.S. Cl. CPC H04W 52/26; H04W 24/02

(57) ABSTRACT

A method and apparatus for avoiding transmit power limitations due to specific absorption rate (SAR) constraints. The method maximizes transmit power by transmitting on a first transmitter for a first period of time, second transmitter for a second period of time, through an N^{th} transmitter for an N^{th} period of time. The transmission time periods may or may not overlap, and the SAR distributions may or may not overlap. The transmitters may or may not transmit at different frequencies and may or may not share antennas. The average transmit power may be reduced by the number of transmitters that are periodically transmitting. The period of transmission for a given transmitter may be inversely proportional to the measured SAR for that particular transmitter.

### FIELD

The present disclosure relates generally to wireless communication systems, and more particularly to a method and apparatus for increasing the specific absorption rate (SAR) constrained transmit power level by introducing an additional duty cycle that periodically switches between transmit antennas, where the duty cycle is determined based on the SAR distributions of each individual transmitting antenna.

### BACKGROUND

Wireless communication devices have become smaller and more powerful as well as more capable. Increasingly users rely on wireless communication devices for mobile phone use as well as email and Internet access. At the same time, devices have become smaller in size. Devices such as cellular telephones, personal digital assistants (PDAs), laptop computers, and other similar devices provide reliable service with expanded coverage areas. Such devices may be referred to as mobile stations, stations, access terminals, user terminals, subscriber units, user equipments, and similar terms.

A wireless communication system may support communication for multiple wireless communication devices at the same time. In use, a wireless communication device may communicate with one or more base stations by transmissions on the uplink and downlink. Base stations may be referred to as access points, Node Bs, or other similar terms. The uplink or reverse link refers to the communication link from the wireless communication device to the base station, while the downlink or forward link refers to the communication from the base station to the wireless communication devices.

Wireless communication systems may be multiple access systems capable of supporting communication with multiple users by sharing the available system resources, such as bandwidth and transmit power. Examples of such multiple access systems include code division multiple access (CDMA) systems, time division multiple access (TDMA) systems, frequency division multiple access (FDMA) systems, wideband code division multiple access (WCDMA) systems, global system for mobile (GSM) communication systems, enhanced data rates for GSM evolution (EDGE) systems, and orthogonal frequency division multiple access (OFDMA) systems.

Wireless devices, including mobile telephones are required to undergo testing to determine the amount of RF energy a user may be exposed to when using the device. In the U.S., the Federal Communications Commission (FCC) certifies mobile devices to ensure compatibility with requirements and user safety. The maximum power that a mobile device may use when transmitting is affected by the fact that users position the device against their head and body. The close proximity or contact is behind the FCC requirements setting limits on the specific absorption rate. SAR is defined as the power absorbed per unit mass of tissue in mW/g by regulatory bodies, including the FCC. Current FCC testing requirements allow for a finite separation distance between the smartphone and the torso portion of a human phantom.

As mobile devices become more popular, and with increasing use of smartphones, the regulatory bodies may require SAR testing with closer or zero separation distance. This will reduce the maximum transmit power drastically. Measured SAR is directly proportional to the average power of transmission. Peak power to average power of transmission varies depending on the communication technology used. For one example, in a GSM system, peak to average power ratio is 8.3 W/g, while for a CDMA system it is 1.0 W/g, which results in a typical peak power transmission for GSM of approximately 9 dB higher than for CDMA. There is a need in the art for a method and apparatus to avoid drastic reductions in maximum permitted transmit power, and to allow higher overall transmit power for mobile devices, while still meeting safety regulations.

### SUMMARY

Embodiments described herein provide a method for avoiding transmit power limitations due to SAR constraints. The method maximizes transmit power by transmitting on a first antenna for a first period of time. After the end of the first period of time, transmission is switched to a second antenna and transmission occurs for a second period of time. The method provides for switching between N antennas, with each antenna transmitting one out of N periods of time in a time-division multiplexing manner, while at the same time accounting for any overlap in SAR distributions of all transmitting antennas. The average transmit power may be reduced by the number of antennas that are periodically transmitting. The period of transmission may be inversely proportional to a measured SAR of the first, second, or Nth antenna.

A further embodiment provides an apparatus for avoiding limits on transmit power caused by SAR constraints. The mobile device includes at least two transmit antennas coupled to a transceiver or two transmitters coupled to an antenna, a power supply coupled to the transceiver; and a memory coupled to a data processor.

A still further embodiment provides an apparatus for avoiding transmit power limitations caused by SAR constraints. The apparatus includes means for transmitting on a first antenna on the mobile device for a first period of time; and means for switching transmission to a second antenna on the mobile device for a second period of time; the apparatus may also include means for transmitting at a first frequency on an antenna on the mobile device for a first period of time; and means for switching transmission to a second frequency on the same antenna on the mobile device for a second period of time. This embodiment also provides for operation when the two antennas have overlapping SAR distributions.

### BRIEF DESCRIPTION OF THE DRAWINGS

FIG. 1 illustrates a wireless multiple-access communication system, in accordance with certain embodiments of the disclosure.

FIG. 2 is a block diagram of a wireless communication system in accordance with embodiments of the disclosure.

FIG. 3 illustrates a human phantom used for SAR testing and also illustrates a SAR distribution of a transmitter in accordance with embodiments of the disclosure.

FIG. 4 illustrates SAR distributions for a multiple transmitter mobile device, in accordance with certain embodiments of the disclosure.

FIG. 5a illustrates the SAR distributions for two transmitters in accordance with certain embodiments of the disclosure.

FIG. 5b illustrates the SAR distributions for two transmitters operating in different frequency bands in accordance with certain embodiments of the disclosure.

FIG. 6 shows the effect of each antenna on the overlapped distributions of transmit power SAR for a mobile device with multiple antennas, in accordance with certain embodiments of the disclosure.

FIG. 7a is a flow diagram of a method for avoiding transmit power limitations by using an additional duty cycle, in accordance with certain embodiments of the disclosure.

FIG. 7b is a flow diagram of a further method for avoiding transmit power limitations by using an additional duty cycle, in accordance with certain embodiments of the disclosure.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, an integrated circuit, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network, such as the Internet, with other systems by way of the signal).

Furthermore, various aspects are described herein in connection with an access terminal and/or an access point. An access terminal may refer to a device providing voice and/or data connectivity to a user. An access wireless terminal may be connected to a computing device such as a laptop computer or desktop computer, or it may be a self-contained device such as a cellular telephone. An access terminal can also be called a system, a subscriber unit, a subscriber station, mobile station, mobile, remote station, remote terminal, a wireless access point, wireless terminal, user terminal, user agent, user device, or user equipment. A wireless terminal may be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. An access point, otherwise referred to as a base station or base station controller (BSC), may refer to a device in an access network that communicates over the air-interface, through one or more sectors, with wireless terminals. The access point may act as a router between the wireless terminal and the rest of the access network, which may include an Internet Protocol (IP) network, by converting received air-interface frames to IP packets. The access point also coordinates management of attributes for the air interface.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ), and integrated circuits such as read-only memories, programmable read-only memories, and electrically erasable programmable read-only memories.

Various aspects will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

Other aspects, as well as features and advantages of various aspects, of the present invention will become apparent to those of skill in the art through consideration of the ensuring description, the accompanying drawings and the appended claims.

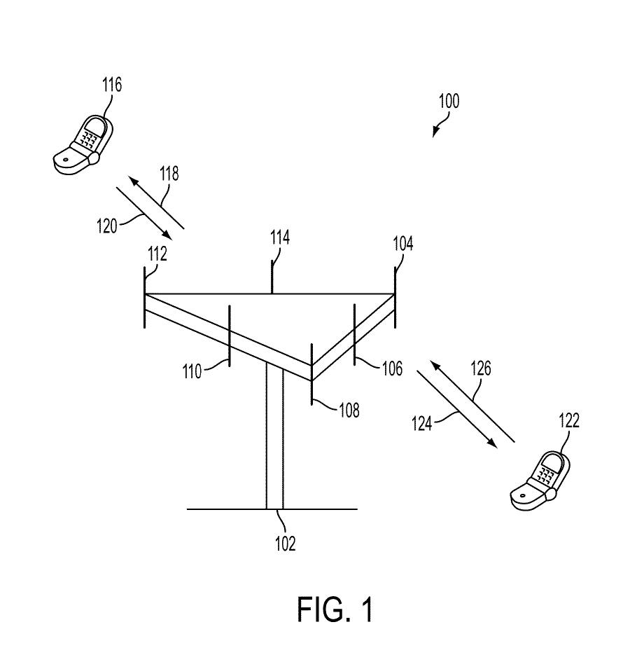

FIG. 1 illustrates a multiple access wireless communication system 100 according to one aspect. An access point 102 (AP) includes multiple antenna groups, one including 104 and 106, another including 108 and 110, and an additional one including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over downlink or forward link 118 and receive information from access terminal 116 over uplink or reverse link 120. Access terminal 122 is in communication with antennas 106 and 108, where antennas 106 and 108 transmit information to access terminal 122 over downlink or forward link 124, and receive information from access terminal 122 over uplink or reverse link 126. In a frequency division duplex (FDD) system, communication link 118, 120, 124, and 126 may use a different frequency for communication. For example, downlink or forward link 118 may use a different frequency than that used by uplink or reverse link 120.

Each group of antennas and/or the area in which they are designed to communicate is often referred to as a sector of the access point. In an aspect, antenna groups are each designed to communicate to access terminals in a sector of the areas covered by access point 102.

In communication over downlinks or forward links 118 and 124, the transmitting antennas of an access point utilize beamforming in order to improve the signal-to-noise ration (SNR) of downlinks or forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as a Node B, an evolved Node B (eNB), or some other terminology. An access terminal may also be called a mobile station, user equipment (UE), a wireless communication device, terminal or some other terminology. For certain aspects, either the AP 102, or the access terminals 116, 122 may utilize the techniques described below to improve performance of the system.

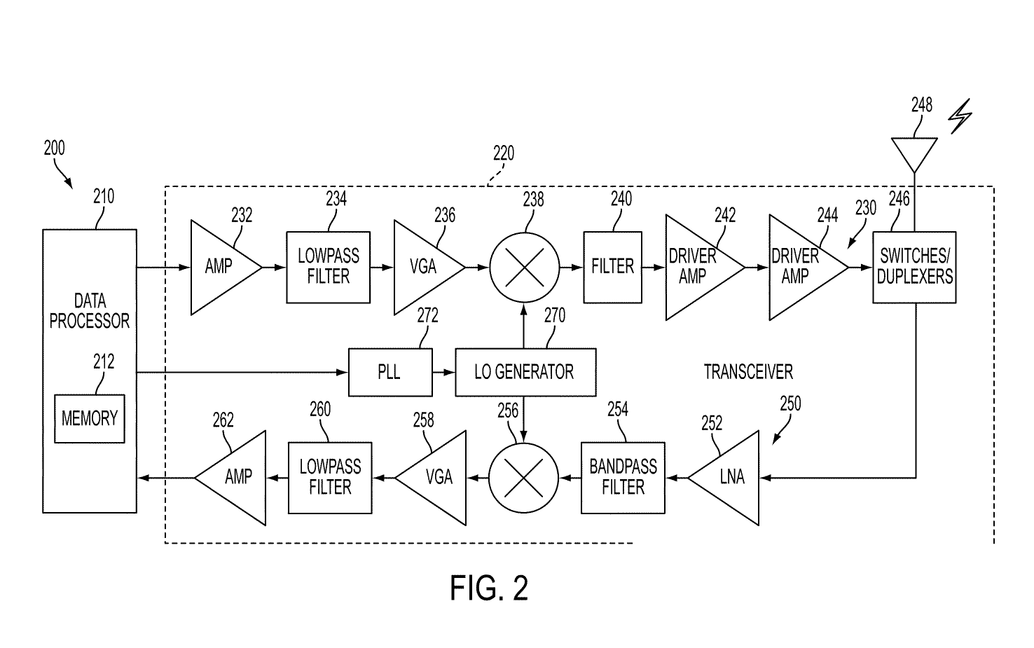

FIG. 2 shows a block diagram of an exemplary design of a wireless communication device 200. In this exemplary design, wireless device 200 includes a data processor 210 and a transceiver 220. Transceiver 220 includes a transmitter 230 and a receiver 250 that support bi-directional wireless communication. In general, wireless device 200 may include any number of transmitters and any number of receivers for any number of communication systems and any number of frequency bands.

In the transmit path, data processor 210 processes data to be transmitted and provides an analog output signal to transmitter 230. Within transmitter 230, the analog output signal is amplified by an amplifier (Amp) 232, filtered by a lowpass filter 234 to remove images caused by digital-to-analog conversion, amplified by a VGA 236, and upconverted from baseband to RF by a mixer 238. The upconverted signal is filtered by a filter 240, further amplified by a driver amplifier, 242 and a power amplifier 244, routed through switches/duplexers 246, and transmitted via an antenna 249.

In the receive path, antenna 248 receives signals from base stations and/or other transmitter stations and provides a received signal, which is routed through switches/duplexers 246 and provided to receiver 250. Within receiver 250, the received signal is amplified by an LNA 252, filtered by a bandpass filter 254, and downconverted from RF to baseband by a mixer 256. The downconverted signal is amplified by a VGA 258, filtered by a lowpass filter 260, and amplified by an amplifier 262 to obtain an analog input signal, which is provided to data processor 210.

FIG. 2 shows transmitter 230 and receiver 250 implementing a direct-conversion architecture, which frequency converts a signal between RF and baseband in one stage. Transmitter 230 and/or receiver 250 may also implement a super-heterodyne architecture, which frequency converts a signal between RF and baseband in multiple stages. A local oscillator (LO) generator 270 generates and provides transmit and receive LO signals to mixers 238 and 256, respectively. A phase locked loop (PLL) 272 receives control information from data processor 210 and provides control signals to LO generator 270 to generate the transmit and receive LO signals at the proper frequencies.

FIG. 2 shows an exemplary transceiver design. In general, the conditioning of the signals in transmitter 230 and receiver 250 may be performed by one or more stages of amplifier, filter, mixer, etc. These circuits may be arranged differently from the configuration shown in FIG. 2. Some circuits in FIG. 2 may also be omitted. All or a portion of transceiver 220 may be implemented on one or more analog integrated circuits (ICs), RF ICs (RFICs), mixed-signal ICs, etc. For example, amplifier 232 through power amplifier 244 in transmitter 230 may also be implemented on an RFIC. Driver amplifier 242 and power amplifier 244 may also be implemented on another IC external to the RFIC.

Data processor 210 may perform various functions for wireless device 200, e.g., processing for transmitter and received data. Memory 212 may store program codes and data for data processor 210. Data processor 210 may be implemented on one or more application specific integrated circuits (ASICs) and/or other ICs.

Wireless devices, such as mobile phones used in the network described above in FIG. 1 generate transmit power that, at high levels, may harm users. This transmit power is used to access the network and is generated by the transmit chain described in FIG. 2. The transmit power of the mobile device at high levels is capable of adversely affecting human health and safety.

SAR is a measure of the rate at which energy is absorbed by the human body when exposed to an RF electromagnetic field. SAR is defined as the power absorbed per mass of tissue, and has units of watts per kilogram (W/Kg). SAR may be either averaged over the entire body, known as whole body exposure, or averaged over a smaller sample volume (typically 1 g or 10 g of tissue), known as localized exposure. The resulting value cited is the maximum level measured in the body part studied over the stated volume or mass.

The SAR for electromagnetic energy may be calculated from the electric field within the tissue as:

$$SAR = {\int }_{sample} \frac{σ ( r ) {\vert E ( r ) \vert}^{2}}{ρ ( r )} d r$$

where σ is the sample electrical conductivity
E is the root mean square (RMS) electric field
ρ is the sample density
r covers the sample region of the body

SAR measures exposure to RF fields between 100 kHz and 10 GHz (generally known as radio waves). It is commonly used to measure the power absorbed by the human body. The SAR value is significantly dependent on the geometry of the body part exposed to the RF energy, and also on the exact location and geometry of the RF source. As a result, each mobile device model must be tested with each specific source at the intended use position.

When measuring the SAR of a wireless device the device is placed at the head in a talk position or flat next to the body phantom. The SAR value is then measured at the location with the highest absorption rate. Typically, for a wireless device, the highest values are generated near the antenna. SAR values depend heavily on the size of the averaging volume.

The maximum transmit power a mobile device may use when transmitting in close proximity with humans is dictated by the limit set on SAR, that is, the power absorbed per unit of mass in tissue in mW/g. This limit is set by various regulatory bodies worldwide. In the U.S., the FCC sets SAR limits for mobile device transmitters.

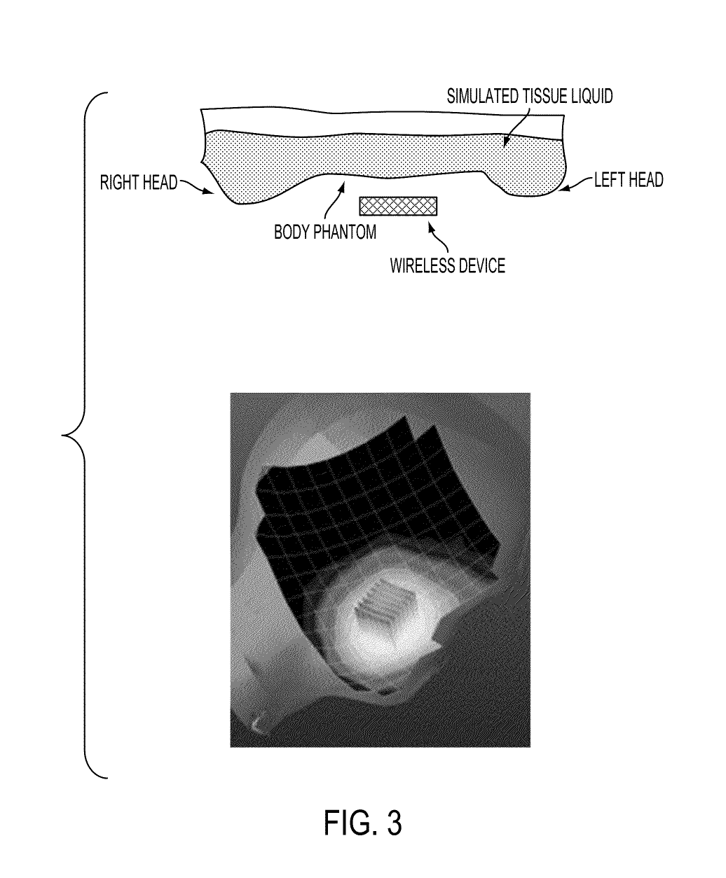

For the body phantom SAR, current FCC testing allows for a finite separation distance between the smartphone device and a human phantom. FIG. 3 depicts the SAR measurement set up with a body phantom. At present, testing allows for a finite separation distance between the mobile device and the body phantom of approximately 10 mm. At this separation distance a mobile phone may transmit at a desired power level. As smartphones and other mobile devices become more heavily used and incorporated into daily life, it is possible that regulatory bodies may, in the near future, require SAR testing with closer or zero separation distance. This limitation will likely result in a drastic limitation on maximum transmit power.

Embodiments described below provide a method for avoiding transmit power limitations arising from SAR constraints. The methods and apparatus maximize transmit power by transmitting on a first antenna for a first period of time. After the end of the first period of time, transmission is switched to a second antenna and transmission occurs for second period of time. Embodiments provide for switching between N antennas, with each antenna transmitting one out of N periods of time, in a time-division multiplexing manner, while at the same time accounting for any overlap in the SAR distributions of all transmitting antennas. In addition, methods provided herein allow for simultaneous transmissions of multiple antennas as long as the combined SAR distribution after accounting for the duty cycles of all transmitting antennas meet the SAR regulatory limits. The methods and apparatus may also be used with multiple frequency bands that share the same antenna. This is accomplished by periodically cycling between different frequency bands, assuming that the peak SAR occurs at different locations for the different frequency bands.

As wireless devices add more transmit antennas, it becomes difficult to locate antennas within the wireless device with sufficient separation so that there is no overlap of SAR distributions. Current methods and apparatus are restricted to antennas with no overlap in SAR distributions and do not allow simultaneous transmissions at any given time. Using the methods and apparatus described herein, the average transmit power per antenna (or transmitter) may be reduced by the number of antennas (or transmitters) that are periodically transmitting, while maximizing the total average transmit power from the device. They duty cycle for transmission for each antenna (or transmitter) may be inversely proportional to the individual measured SAR if there is no overlap in SAR distributions from other transmitting antennas.

Alternatively, if there is an overlap in SAR distributions, then there will be regions in the human body that are continuously exposed, even when the antennas transmit in a time-division multiplexing manner. In such a situation, the duty cycle of transmission for each alternating transmit antenna (or transmitter) may be determined to be inversely proportional to the peak value of the individual SAR distribution, plus the overlapped SAR distribution from the other transmitting antennas (or transmitters).

The measured SAR value and the volume-averaged SAR distribution for each transmit antenna may be stored in the wireless device in order to determine the duty cycle of each antenna depending on the transmission scenario in real time.

An additional embodiment saves memory on the mobile device, as there may be a need to convert two-dimensional SAR area scan data of an individual transmitting antenna to three-dimensional SAR volume data to determine a volume-averaged SAR distribution. This may be done using an analytical estimation technique such as described in Kanda et al. “Faster determination of mass-averaged SAR from 2-D area scans” IEEE Trans. Microwave Theory Techniques 52(8) 2013-2020. A technique similar to that found in Marckel et al., “Parametric model approach for rapid SAR measurements” IMTC 2004 Instrumentation and Measurement Tech. Conference, pp 178-185, Como, Italy, May 2004, may also be used. In this process, the errors associated with the analytical estimations may be included in order to obtain a conservative estimate of the local SAR value when there is an overlap in the SAR distributions.

FIG. 3 also shows the spatial SAR distribution for an antenna located at the bottom of a mobile device. As shown in FIG. 3, the SAR is concentrated near the antenna location.

Measured SAR is directly proportional to the average power of transmission. The duty cycle of transmission defined in each communication technology varies. For example, for a GSM system, the duty cycle is 8.3, while for a CDMA system it is 1.0. At the present, if the average power for a given communication technology cannot meet SAR requirements, then the transmission power must be reduced from the mobile device when operating with that technology.

Limiting transmit power is unsatisfactory, as this may result in poor mobile device performance. As mobile devices have evolved and become more capable, the performance possible has increased. This increase in performance has been accomplished through the use of multiple transmitters and antennas. Embodiments discussed below provide for a method and apparatus that switches transmission periodically between the multiple transmitters that are spatially separate from one another, resulting in an average power of transmission for any given transmitter and/or antenna being lowered, and allowing higher overall transmit power for mobile device.

An additional duty cycle in transmission power may be provided by periodically switching between multiple transmit antennas. The average transmit power of any given antenna may be reduced by the number of antennas being periodically switched.

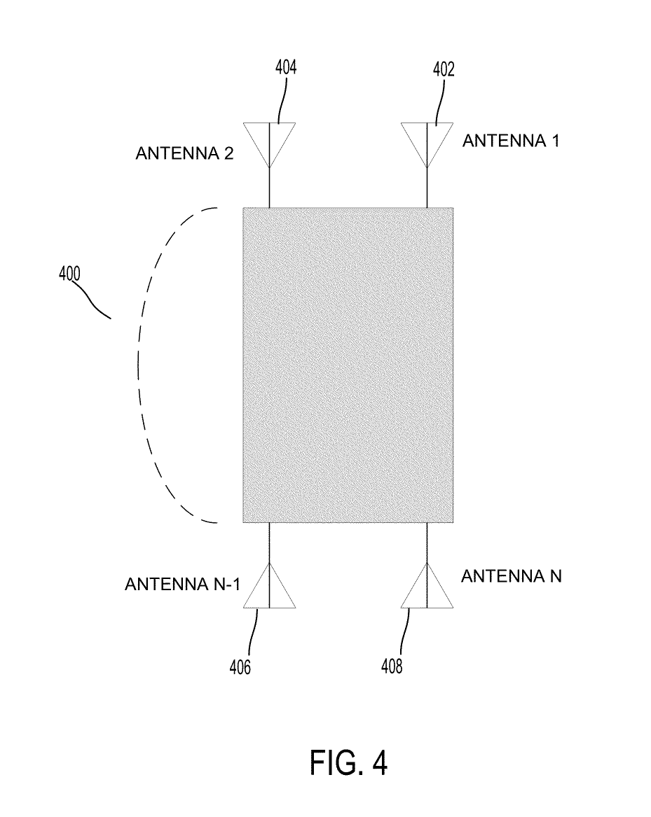

FIG. 4 illustrates a mobile device 400 having multiple antennas. Antenna 1 402, antenna 2 404, antenna N−1 406, and antenna N 408 are disposed around the mobile device 400. Each antenna may be used for both transmitting and receiving. An additional duty cycle in transmission power is provided by periodically switching between the multiple transmit antennas. As a result, the average transmit power of any given antenna is reduced by the number of antennas periodically switched. It is preferable that the switchable transmit antenna be spatially separated from each other, as depicted in FIG. 4. This spatial separation allows for minimal overlap in the measured SAR distribution patterns of the antennas. Should such spatial separation not be feasible due to size limitations, then the gain obtained in transmit power for a given antenna may be lowered by the amount of overlap in the SAR distributions of the other antennas.

In a case where one or more antennas are transmitting and in order to maximize the total transmission power, the SAR distribution typically may not be completely isolated from one antenna to another. This results from the size limitations of a wireless device. In such situations, the overlapped SAR may need to be considered in order to determine the duty cycle of transmission for each of the switchable antennas.

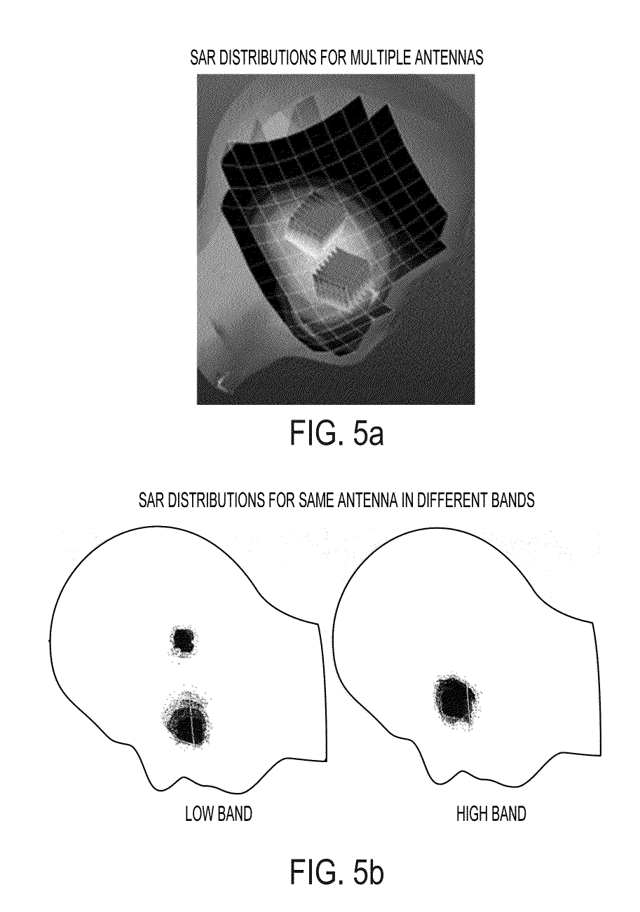

FIG. 5a illustrates the SAR distributions for two transmitters, Tx1 and Tx2. As shown in FIG. 5a, the combined SAR distributions are spread out over a larger area than the single SAR distribution shown in FIG. 3. The total allowable transmitter power from the mobile device for compliance with SAR limits may be less due to the overlapped SAR distribution.

In addition, the same antenna may be shared by switching between multiple transmitters, each operating in a different frequency band. Operation in a different frequency band results in different SAR distributions and peak SAR locations, as illustrated in FIG. 5b. Therefore, N transmitters in a mobile device may have a number of antennas that are different from N. Transmitters and transmitting antennas may be used interchangeably, however, the goal is to control the duty cycle of transmission for N transmitters that may or may not use N number of antennas. The SAR distribution information may also be stored in the wireless device so that the SAR assessment and determination of duty cycles may be performed in real time.

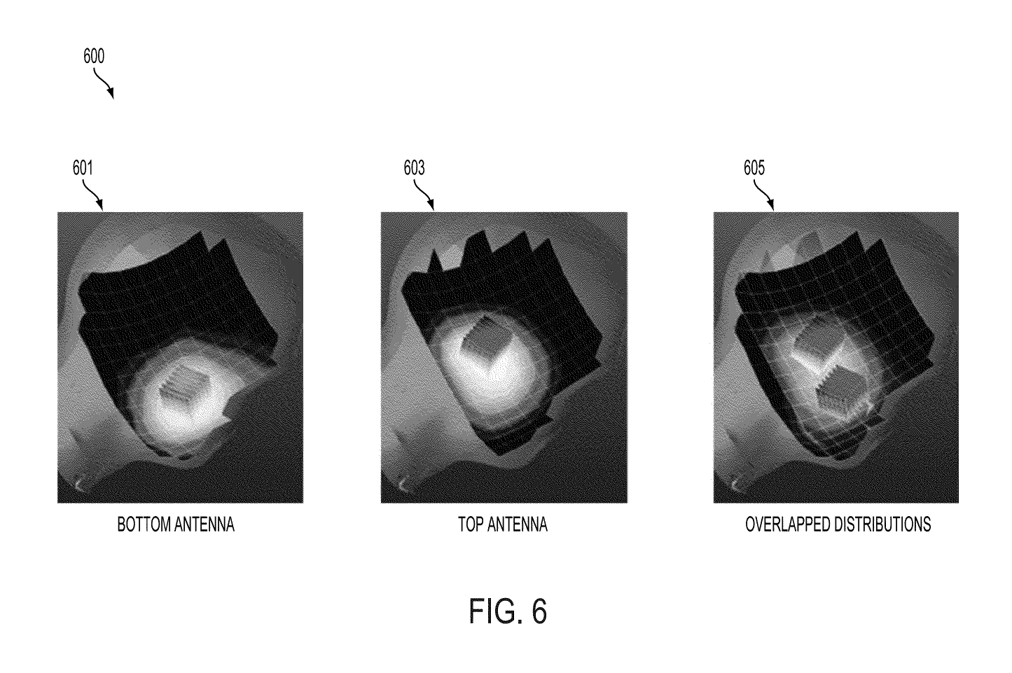

FIG. 6 illustrates the location of SAR readings 600 when various antennas on a mobile device, such as that shown in FIG. 4, are active. The first FIG. 601 shows the location of the SAR reading when a bottom antenna, such as Antenna N−1 406 or Antenna N 408 is active. The second FIG. 603 shows the location of the SAR reading when a top antenna, such as Antenna 1 402 or Antenna 2 404 is active. The third FIG. 605 shows how the SAR distributions overlap within the mobile device.

In a wireless device, where the SAR distributions of multiple transmitting antennas do not overlap, the maximum duty cycle of each switchable antenna may be inversely proportional to the measured SAR of the individual antenna, as given by the equation below.

Max. duty cycle for a given transmitting antenna=(regulatory SAR limit)/(peak measured SAR for that particular transmitting antenna at its maximum transmission power)

If the measured SAR for a given transmitting antenna is less than the regulatory SAR limit, then the maximum duty cycle for that antenna is 1.

This allows maximizing the overall transmit power of the mobile device. Because this information is measured during the testing of the mobile device, it may be stored in memory on the mobile device.

In an operating scenario where all of the antennas periodically transmit for a fraction of time in a sequence without any overlap in transmit time fractions (i.e., only one antenna transmits at a time), but the SAR distributions of the antennas may overlap, the calculation of duty cycles in a wireless device having N transmitters is based on the conditions below:

combined 1 g/10 g averaged SAR distribution=Σᵢ₌₁^{N}(duty cycleᵢ*1 g/10 g averaged SARᵢ distribution) a)

peak combined 1 g/10 SAR=peak value of combined 1 g/10 g averaged SAR b)

peak combined 1 g SAR<=Regulatory limit of 1.6 mW/g c)

Typically, the duty cycle of a given switchable antenna should be inversely proportional to its measured peak SAR value in order to maximize the overall transmit power from the device. The sum of the duty cycle from all of the antennas is equal to or less than 1. The duty cycle information may be stored in the mobile device. Alternatively, the SAR distribution of each individual antenna may be stored in the mobile device to support a dynamic change of duty cycle for each antenna.

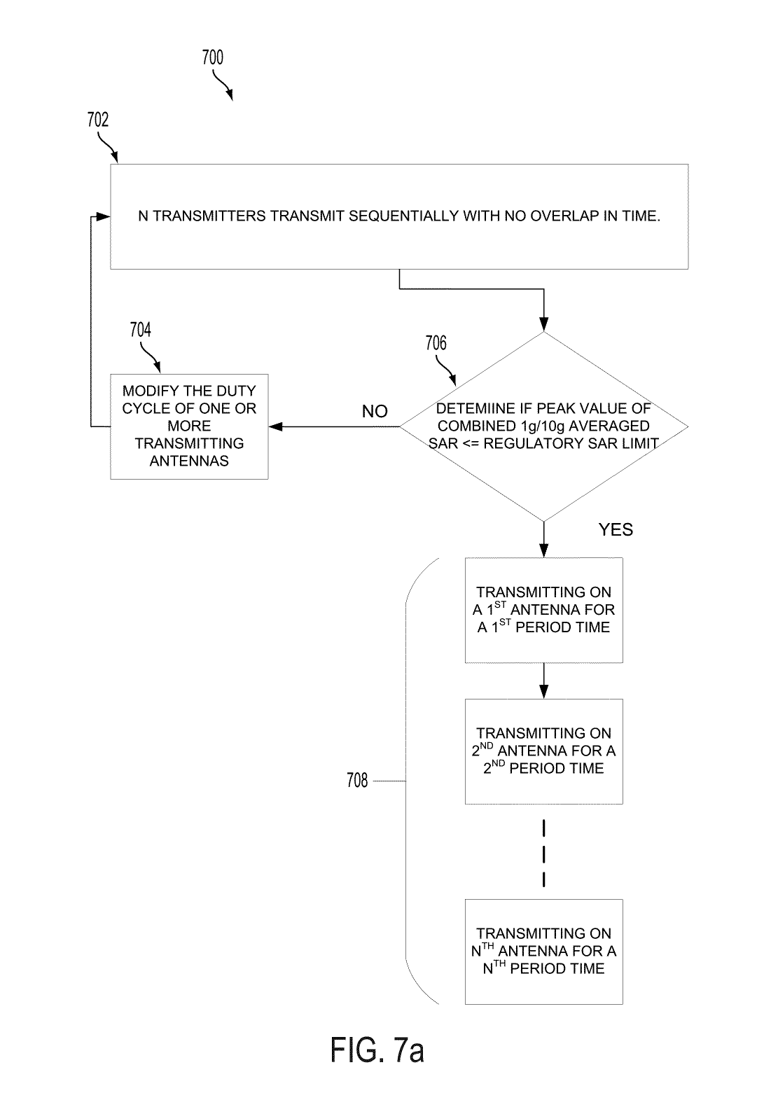

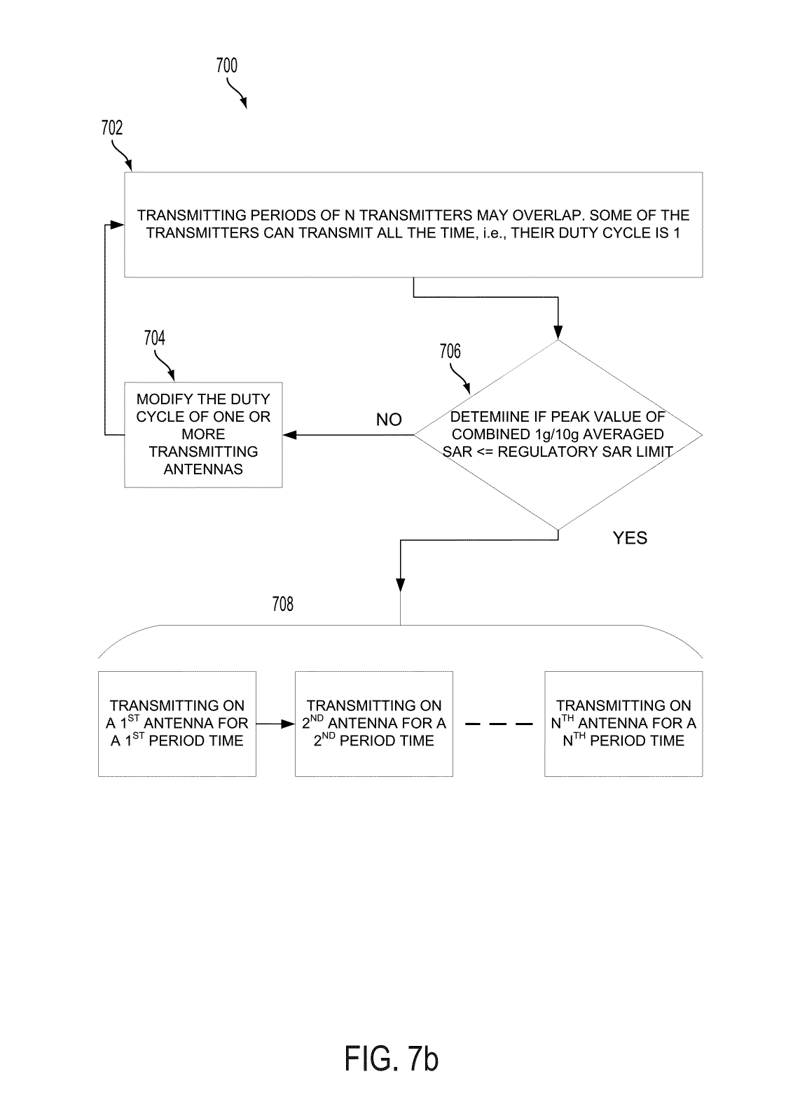

FIG. 7a is a flowchart of a method of avoiding constraints on transmit power according to embodiments discussed herein, specifically a dynamic change of duty cycle for each antenna. The method 700 begins with a mobile device containing N transmitting antennas that transmit periodically with varying duty cycles. Because the time periods of the transmitting antennas do not overlap, the mobile device switches between these antennas sequentially in a time division multiplex manner. In step 702, the combined 1 g/10 SAR averaged distributions is calculated based on the initial duty cycle values for all N transmitting antennas. Since the antennas transmit in a time-multiplex manner, the sum of all duty cycles will be less than or equal to 1. The 1 g/10 g averaged SAR distributions for each transmitting antenna are analytically estimated from measured area scans as described above. In step 704, the peak value of the combined 1 g/10 g averaged SAR distribution is computed and compared with the regulatory SAR limit. If the peak combined SAR value is greater than the regulatory SAR limit, then the duty cycles are modified. In step 706, steps 702 and 704 are repeated until the SAR compliance is achieved for the duty cycles of the transmitting antennas. Then, in step 708, the mobile device transmits on a first antenna for a first period of time, then transmits on a second antenna for a second period of time, and so on, with the N^{th} antenna transmits for an N^{th} period of time, periodically repeating in a time-multiplex manner. The method 700 may be repeated for various combinations of transmitting antennas on the mobile device.

The method 700 may be performed in advance and the duty cycle information may be stored in the mobile device for a given combination of transmitting antennas. Alternatively, the method 700 may be performed in real time on the mobile device using stored SAR distributions for all transmitting antennas. This allows flexibility in changing the duty cycles for transmitting antennas based on communication priorities such as voice transmission, and also allows a higher priority to be set for data transmission.

When all the antennas periodically transmit for a fraction of time with or without overlap in transmit time fractions (i.e., simultaneous transmissions), and the SAR distributions for the antennas may or may not overlap, then the calculation of duty cycles in a wireless device having N transmitters is based on satisfying the conditions below:

combined 1 g/10 g averaged SAR distribution=Σᵢ₌₁^{N}(duty cycleᵢ*1 g/10 g averaged SARᵢ distribution) a)

peak combined 1 g/10 SAR<=peak value of combined 1 g/10 g averaged SAR b)

peak combined 1 g SAR<=Regulatory limit of 1.6 mW/g c)

In this situation, the duty cycle for a given transmitting antenna may be equal to 1. The sum of the duty cycle from all of the antennas may be greater than 1 if there are simultaneous transmissions for any fraction of time. The duty cycle information may be stored in the mobile device. The SAR distribution of each individual antenna may also be stored in the mobile device in order to support dynamic change of the duty cycle for each antenna. FIG. 7b illustrates this method.

FIG. 7b is a further flowchart of an alternative method of avoiding constraints on transmit power as discussed above. The method 700 begins with a mobile device containing N transmitting antennas transmitting with varying duty cycles. Because the time periods of the transmitting antennas may overlap, the mobile device may be simultaneously transmitting with multiple antennas for any given fraction of time and may not follow sequential transmission in a time-multiplex manner. In step 702, the combined 1 g/10 g SAR averaged distributions is calculated based on initial duty cycle values for all N transmitting antennas. Since the antennas may transmit simultaneously, the duty cycle of any antenna may be equal to 1, and the sum of all duty cycles may be greater than 1. The 1 g/10 g averaged SAR distribution for each transmitting antenna may be analytically estimated as described previously. In step 704, the peak value of the combined 1 g/10 g averaged SAR distribution is computed and compared with the regulatory SAR limit. If the peak combined 1 g/10 g SAR value is greater than the regulatory SAR limit, then the duty cycles are modified in step 706. In step 706, steps 702 and 704 may be repeated until compliance is obtained. Once the regulatory SAR limit is met for the determined duty cycles of transmitting antennas, then in step 708, the mobile device transmits on a first antenna for a first period of time, the second antenna transmits for a second period of time, and continues until the N^{th} antenna transmits for an N^{th} period of time. These transmissions may or may not overlap and may be in any order. The method 700 in FIG. 7b may be repeated for various combinations of transmitting antennas on the mobile device. The method reduces the average transmit power of any given antenna by the number of antennas being periodically switched. In addition, the method may be performed in advance and the duty cycle information may be stored in the mobile device for a given combination of transmitting antennas. Alternatively, the method may be performed in real time on the mobile device using stored SAR distributions for all transmitting antennas.

In the method 700, the duty cycle, or transmission time spent on a particular antenna may be determined by utilizing a duty cycle that is typically inversely proportional to the measured SAR of the antenna in question. This allows for variation in the antennas present on the mobile device and permits maximizing the overall transmit power of the mobile device.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitter over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM EEPROM, CD-ROM or other optical disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

1. A method of maximizing transmit power of a mobile device, comprising:
transmitting on a first antenna at a first frequency on the mobile device for a first period of time; and
switching transmitting to a second antenna at a second frequency for a second period of time, based on a measured specific absorption rate (SAR) value.

2. The method of claim 1, wherein:
periods of transmitting antennas may or may not overlap.

3. The method of claim 1, wherein a specific absorption rate (SAR) distribution for each transmitting antenna may or may not overlap.

4. The method of claim 1, wherein two or more transmitters transmit at a same frequency.

5. The method of claim 1, wherein the first antenna transmits at a first frequency for a first period of time and at a second frequency for a second period of time, and the second antenna does not transmit.

6. The method of claim 3, wherein the first and second period of time are each inversely proportional to a measured specific absorption rate (SAR) of the first and second antennas on the mobile device when there is no overlap in SAR distributions.

7. The method of claim 3, wherein the first and second period of time are each inversely proportional to an individually measured specific absorption rate (SAR) of the first and second antennas plus a contribution to a peak SAR location from the first and second antennas if the SAR distributions overlap.

8. The method of claim 3, wherein computation of the SAR distribution is performed in real time.

9. The method of claim 1, wherein the first and second period of time are stored on the mobile device.

10. A mobile device, comprising:
two transmit antennas coupled to a transceiver;
a power supply coupled to the transceiver; and
a memory storing measured specific absorption rate (SAR) values coupled to a data processor capable of switching between the two transmit antennas.

11. The mobile device of claim 10, further comprising:
Nth additional antennas coupled to the transceiver.

12. The mobile device of claim 10, wherein the two transmit antennas are separated from each other.

13. The mobile device of claim 11, wherein the Nth additional antennas are spatially separated.

14. An apparatus for maximizing transmit power of a mobile device, comprising:
means for transmitting on a first antenna at a first frequency on the mobile device for a first period of time; and
means for switching transmitting to a second antenna at a second frequency on the mobile device for a second period of time, based on a measured specific absorption rate (SAR) value.

15. The apparatus of claim 14, wherein the means for transmitting transmit on a same frequency.

16. The apparatus of claim 14, wherein the means for transmitting on a first antenna transmits at a first frequency for a first period of time and then transmits at a second frequency for a second period of time and the means for switching transmitting does not switch transmitting to a second means for transmitting.

17. The apparatus of claim 14, further comprising:
means for reducing an average transmit power for a given frequency by a number of antennas on the mobile device that transmit at that frequency.

18. The apparatus of claim 14, further comprising:
means for adjusting the first and second period of time to be inversely proportional to a measured specific absorption rate (SAR) of the first and second antennas of the mobile device if the SAR distributions do not overlap.

19. The apparatus of claim 14, further comprising:
means for adjusting the first and second period of time to be inversely proportional to an individual measured specific absorption rate (SAR) of the first and second antennas plus a contribution to peak SAR location from the first and second antennas, when there is overlap in SAR distributions.

20. The apparatus of claim 14, further comprising: means for adjusting the first period of time and the second period of time based on transmission priorities of the mobile device, wherein the adjusting occurs in real time.
